(19) United States
(12) Patent Application Publication
(10) Pub. No.: US 2012/0318247 A1
(43) Pub. Date: Dec. 20, 2012

(54) EGR CONTROLLER FOR INTERNAL COMBUSTION ENGINE

(75) Inventor: Hiroki Nogami, Kariya-city (JP)

(73) Assignee: DENSO CORPORATION, Kariya-city (JP)

(21) Appl. No.: 13/489,760

(22) Filed: Jun. 6, 2012

(30) Foreign Application Priority Data
Jun. 17, 2011 (JP) 2011-134843

(51) Int. Cl. F02M 25/07

(52) U.S. Cl. 123/568.19

(57) ABSTRACT

A gas temperature sensor is provided in an EGR passage. When a specified learning executing condition is established, the EGR valve is compulsorily rotated from a reference position in a valve-close direction and then rotated in a valve-open direction over the reference position. While the EGR valve is rotated in such a manner as to pass a full-close position, an opening degree of the EGR valve at which the variation in gas temperature becomes minimum is learned as the full-close position of the EGR valve.

### CROSS-REFERENCE TO RELATED APPLICATION

This application is based on Japanese Patent Application No. 2011-134843 filed on Jun. 17, 2011, the disclosure of which is incorporated herein by reference.

### TECHNICAL FIELD

The present invention relates to an exhaust gas recirculation (EGR) controller for an internal combustion engine, which is provided with an EGR valve which controls an exhaust gas quantity recirculating into an intake pipe.

### BACKGROUND

In order to reduce exhaust emission, an internal combustion engine is provided with an exhaust gas recirculation (EGR) apparatus. The EGR apparatus has an EGR valve disposed in an EGR passage. The EGR valve adjusts quantity of EGR gas recirculating into an intake pipe through the EGR passage.

For example, Japanese patent No. 2560777 discloses an internal combustion engine having an EGR apparatus. An oxygen sensor is provided in an intake pipe. Based on output signals of the oxygen sensor, an opening degree of the EGR valve of when the EGR gas starts to recirculate is detected. Further, JP-2001-82260A discloses an internal combustion engine having an EGR apparatus in which an intake pressure sensor is provided in the intake pipe to detect an intake pressure. Based on the detected intake pressure, an opening degree of the EGR valve of when the EGR gas starts to recirculate is learned.

Especially, in a gasoline engine, since a sensitivity of combustion stability relative to an EGR gas quantity is relatively high, it is necessary to control the EGR gas quantity with high accuracy. When the exhaust gas recirculation is stopped, it is necessary for the EGR valve to accurately fully close the EGR passage to avoid an EGR gas leakage. Thus, it is necessary to accurately learn a full close position of the EGR valve.

### SUMMARY

It is an object of the present disclosure to provide an exhaust gas recirculation (EGR) controller for an internal combustion engine, which is able to accurately learn a full-close position of an EGR valve.

According to the present disclosure, an EGR controller includes: an EGR valve controlling an exhaust gas quantity recirculating from an exhaust passage into an intake passage through an EGR passage; a gas temperature detection portion detecting a gas temperature of the exhaust gas recirculating from the exhaust passage into the intake passage; and a full-close position learning portion learning a full-close position of the EGR valve. When a specified learning-executing condition is established, the opening degree of the EGR valve is compulsorily varied, and an opening degree of the EGR valve at which a variation in the temperature detected by the gas temperature detection portion becomes minimum is learned as the full-close position of the EGR valve.

Depending on the opening degree of the EGR valve, the EGR gas quantity varies and the gas temperature in the EGR pipe also varies. Thus, the gas temperature in the EGR pipe varies according to the opening degree of the EGR valve. When the opening degree of the EGR valve is compulsorily varied, the EGR gas quantity and the gas temperature are changed from a decrease to an increase with respect to the full-close position. Thus, when the EGR valve 31 passes the full-close position, the variation in gas temperature becomes minimum. In view of the above characteristics, the EGR valve is compulsorily rotated and an opening degree at which the gas temperature becomes minimum is learned as the full-close position of the EGR valve. Thus, the full-close position of the EGR valve can be accurately learned.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of an engine control system according to a first embodiment of the present invention;

FIGS. 2A and 2B are charts for explaining a rotatable range of an EGR valve;

FIG. 3 is a time chart for explaining a learning of a full-close position according to a first embodiment;

FIGS. 4 and 5 are flow charts for explaining a full-close position learning routine, according to the first embodiment; and

FIG. 6 is a flow chart for explaining a full-close position learning routine, according to a second embodiment.

### DETAILED DESCRIPTION

Embodiments of the present invention will be described, hereinafter.

### First Embodiment

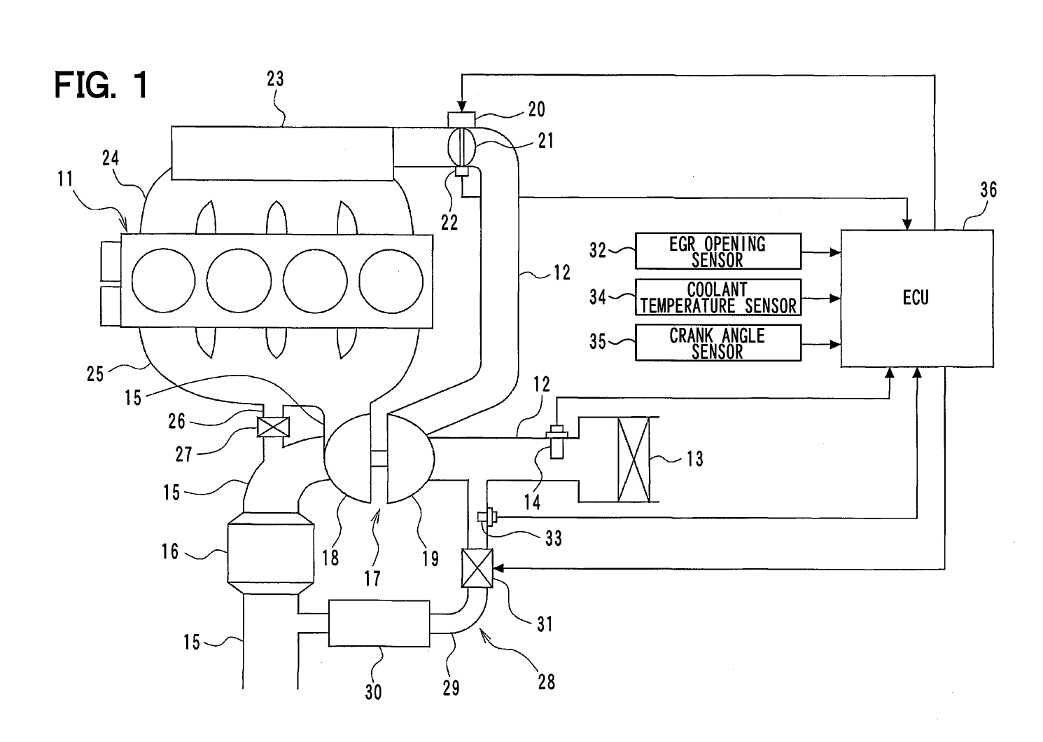

Referring to FIGS. 1 to 5, a first embodiment will be described hereinafter.

An engine control system is schematically explained based on FIG. 1. An air cleaner 13 is arranged upstream of an intake pipe 12 (intake passage) of an internal combustion engine 11. An airflow meter 14 detecting an intake air flow rate is provided downstream of the air cleaner 13. An exhaust pipe 15 (exhaust passage) of the engine 11 is provided with a three-way catalyst 16 which reduces CO, HC, NOx, and the like contained in exhaust gas.

The engine 11 is provided with a turbocharger 17. The turbocharger 17 includes an exhaust gas turbine 18 arranged upstream of the catalyst 16 in the exhaust pipe 15 and a compressor 19 arranged downstream of the airflow meter 14 in the intake pipe 12. This turbocharger 17 has well known configuration which supercharges the intake air into the combustion chamber.

A throttle valve 21 driven by a DC-motor 20 and a throttle position sensor 22 detecting a throttle position (throttle opening degree) are provided downstream of the compressor 19.

An intercooler (not shown) and surge tank 23 is provided downstream of the throttle valve 21. The intercooler may be arranged upstream of the surge tank 23 and the throttle valve 21. An intake manifold 24 which introduces air into each cylinder of the engine 11 is provided downstream of the surge tank 23, and a fuel injector (not shown) which injects fuel is provided for each cylinder. A spark plug (not shown) is mounted on a cylinder head of the engine 11 corresponding to each cylinder to ignite air-fuel mixture in each cylinder.

An exhaust manifold 25 (exhaust passage) is connected to each exhaust port of the cylinder. A confluent portion of the exhaust manifold 25 is connected to the exhaust pipe 15 upstream of the exhaust gas turbine 18. An exhaust bypass passage 26 bypassing the exhaust gas turbine 18 is connected to the exhaust pipe 15. A waste gate valve 27 is disposed in the exhaust bypass passage 26 to open/close the exhaust bypass passage 26.

The engine 11 is provided with an exhaust gas recirculation (EGR) apparatus 28 for recirculating a part of exhaust gas from the exhaust pipe 15 into the intake pipe 12. This EGR apparatus 28 is referred to as low-pressure-loop (LPL) type. The EGR apparatus 28 has an EGR pipe 29 connecting the exhaust pipe 15 downstream of the catalyst 16 and the intake pipe 12 upstream of the compressor 19. An EGR cooler 30 for cooling the EGR gas and an EGR valve 31 for adjusting an exhaust gas recirculation quantity (EGR-quantity) are provided in the EGR pipe 29. The EGR valve 31 is a butterfly valve. The EGR valve 31 is driven by a motor (not shown) and its opening degree is detected by an EGR opening sensor 32. Moreover, a gas-temperature sensor is provided downstream of the EGR pipe 29 for detecting EGR gas temperature in the EGR pipe 29.

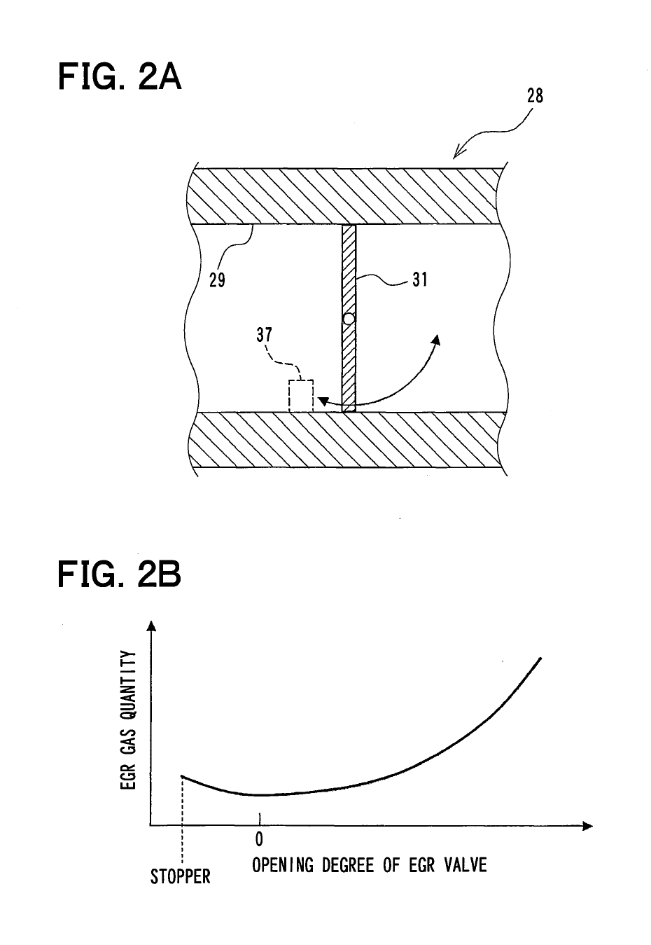

As shown in FIG. 2A, the EGR apparatus 28 has a stopper 37 in a gear box of the EGR pipe 29. When the EGR valve 31 is rotated from a full-close position by small degree, the EGR valve 31 is brought into contact with the stopper 37. The EGR valve 31 can rotate in a valve-close direction and a valve-open direction (clockwise and anticlockwise) with respect to the full-close position. Therefore, the full-close position of the EGR valve 31 does not agree with the position at which the EGR valve 31 is in contact with the stopper 37.

As shown in FIG. 1, the engine 11 is provided with a coolant temperature sensor 34 detecting coolant temperature and a crank angle sensor 35 outputting a pulse signal every when the crank shaft (not shown) rotates a specified crank angle. Based on the output signal of the crank angle sensor 35, a crank angle and an engine speed are detected.

The outputs of the above sensors are transmitted to an electronic control unit (ECU) 36. The ECU 36 includes a microcomputer which executes an engine control program stored in a Read Only Memory (ROM) to control a fuel injection quantity, an ignition timing, a throttle position (intake air flow rate) and the like.

The ECU 36 computes a target EGR quantity or a target EGR rate according to an engine driving condition (engine speed, engine load and the like). The ECU 36 controls the opening degree of the EGR valve 31 to obtain the target EGR quantity or the target EGR rate. For example, the ECU 36 computes a target EGR valve opening degree based on the target EGR quantity or the target EGR rate. The EGR valve 31 is driven so that the opening degree detected by the sensor 32 agrees with the target opening degree of the EGR valve 31.

Especially, in a gasoline engine, since a sensitivity of combustion stability relative to an EGR gas quantity is relatively high, it is necessary to control the EGR gas quantity with high accuracy. When the exhaust gas recirculation is stopped, it is necessary for the EGR valve 31 to accurately fully close the EGR passage to avoid an EGR gas leakage. Thus, it is necessary to accurately learn a full-close position of the EGR valve 31.

The full-close position does not correspond to a position of the stopper 37.

According to the present embodiment, when a specified learning-executing condition is established, the opening degree of the EGR valve 31 is compulsorily varied. At a time when a variation in temperature detected by the gas temperature sensor 33 becomes minimum, its opening degree of the EGR valve 31 is learned as the full-close position.

Depending on the opening degree of the EGR valve 31, the EGR gas quantity varies and the gas temperature in the EGR pipe 29 also varies. Thus, the gas temperature in the EGR pipe 29 varies according to the opening degree of the EGR valve 31. When the opening degree of the EGR valve 31 is compulsorily varied, the EGR gas quantity is changed between a decrease and an increase with respect to the full-close position, as shown in FIG. 2B. Thus, when the EGR valve 31 passes the full-close position, the variation in gas temperature becomes minimum. In view of the above characteristics, the EGR valve 31 is compulsorily rotated and an opening degree at which the gas temperature becomes minimum is learned as the full-close position of the EGR valve 31. Thus, the full-close position of the EGR valve 3 can be accurately learned.

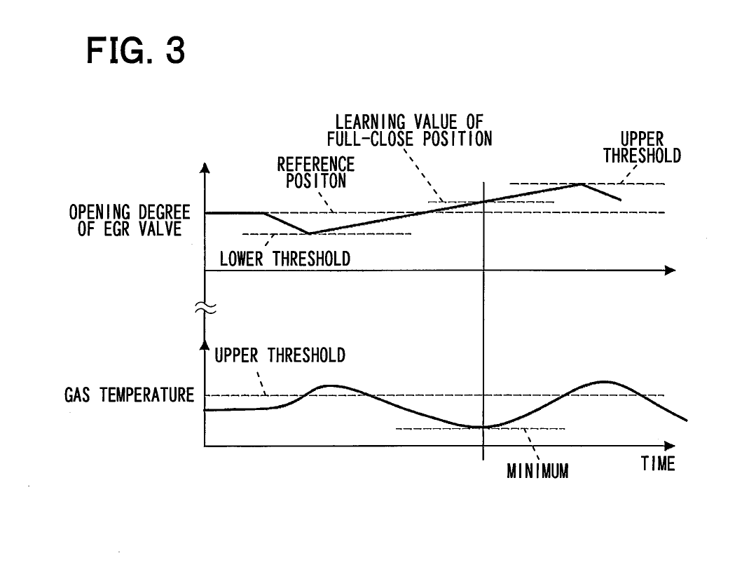

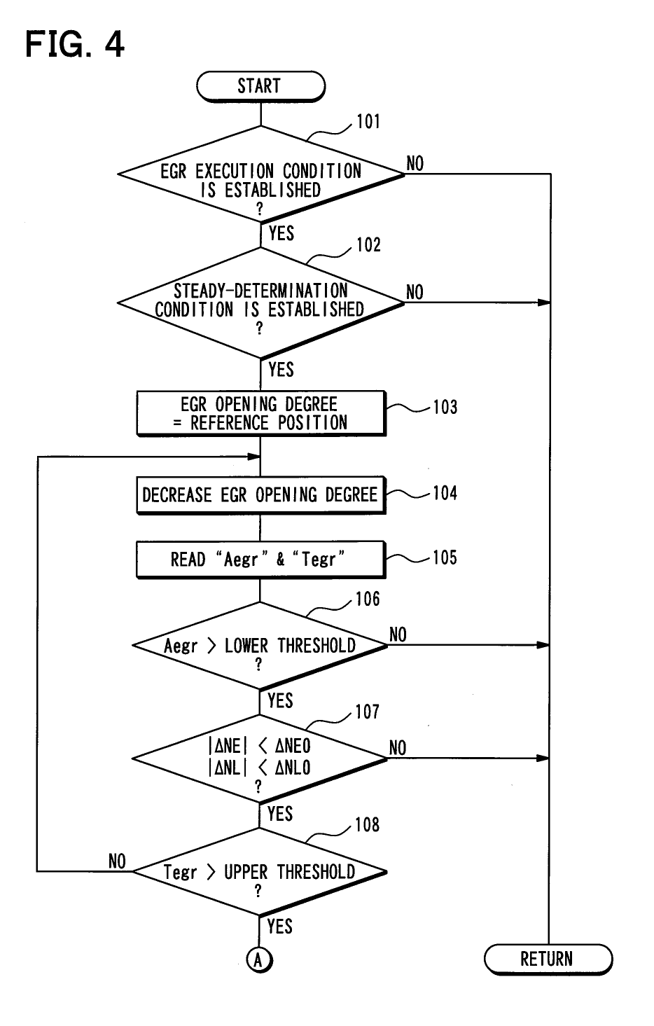

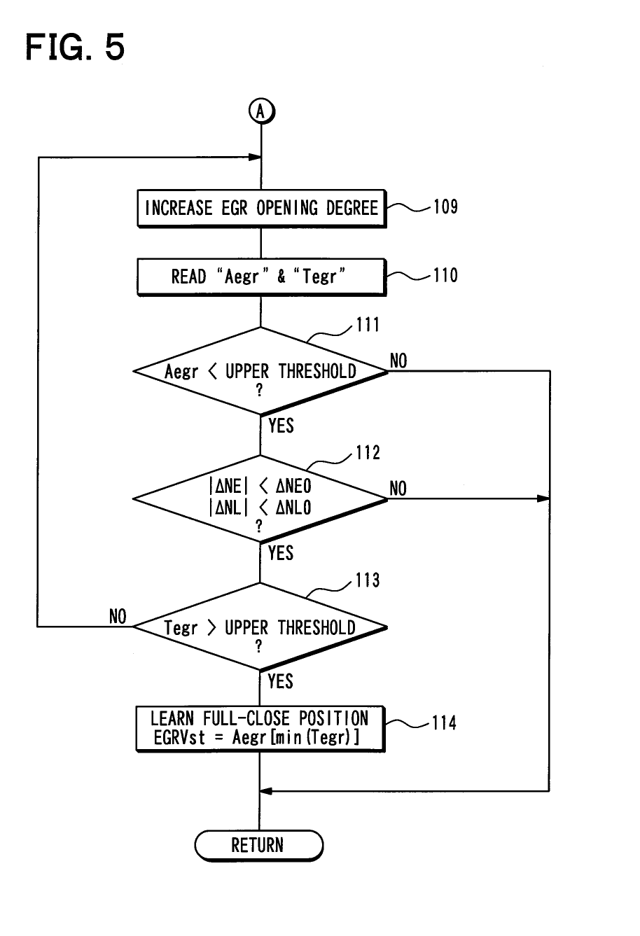

According to the first embodiment, the ECU 36 executes a full-close position learning routine shown in FIGS. 4 and 5. As shown in a time chart in FIG. 3, when a specified learning executing condition is established, the EGR valve 31 is compulsorily rotated from a reference position (for example, a designed full-close position or a previously learned full-close position) in a valve-close direction and then rotated in a valve-open direction over the reference position. While the EGR valve 31 is rotated in such a manner as to pass the full-close position, the opening degree of the EGR valve 31 at which the detected gas temperature becomes minimum is computed. The opening degree at which a variation in gas temperature becomes minimum is obtained and learned as the full-close position.

Referring to FIGS. 4 and 5, the processes of the full-close position learning routine will be described hereinafter.

The full-close position learning routine is executed at a specified cycle while the ECU 36 is ON. This full-close position learning routine corresponds to a full-close position learning portion. In step 101, the computer determines whether an EGR execution condition is established. That is, the computer determines whether the combustion stability of the engine 11 can be ensured even if the opening degree of the EGR valve 31 is varied. If the combustion stability of the engine 11 can not be ensured, the combustion condition is deteriorated due to variation in opening degree of the EGR valve 31.

When the coolant temperature is higher than a warming-up temperature (for example, 60° C.) and the engine speed NE and the engine load NL within a specified region, the computer determines that the EGR execution condition is established.

When the answer is YES in step 101, the procedure proceeds to step 102 in which the computer determines whether a steady-determination condition is established. When the steady-determination condition is established, the exhaust gas quantity is stable and the gas temperature detected by the sensor 33 is stable, so that the learning accuracy of the full-close position of the EGR valve 31 is improved.

For example, when an absolute value of a variation ΔNE in engine speed NE per specified unit time is less than a specified value and when an absolute value of a variation ΔNL in engine load NL per specified unit time is less than a specified value, it is determined that the steady-determination condition is established.

When the answer is NO in step 101, or when the answer is NO in step 102, it is determined that the learning executing condition is not established to end the routine. In this case, the previous learning value of the full-close position “EGRVst(old)” is added to the target opening degree of the EGR valve corresponding to the target EGR quantity is defined as the final target opening degree of the EGR valve.

Meanwhile the answers are YES in steps 101 and 102, the procedure proceeds to step 103.

In step 103, the EGR valve 31 is driven so that the opening degree of thee EGR valve 31 is brought into a reference position. The opening degree of thee EGR valve 31 is referred to as an EGR opening degree, hereinafter. The reference position is a designed full-close position (0 degree) or the previous learning value of the full-close position “EGRVst(old)”.

Then, the procedure proceeds to step 104 in which the EGR valve 31 is driven so that the EGR opening degree is decreased at a specified speed. The EGR opening degree may be decreased linearly or stepwise.

Then, the procedure proceeds to step 105 in which the computer reads an EGR opening degree “Aegr” detected by the sensor 32 and a gas temperature “Tegr” detected by the temperature sensor 33. In step 106, the computer determines whether the EGR opening degree “Aegr” is greater than a lower threshold. The lower threshold is defined smaller than the reference position of the EGR valve 31.

When the answer is YES in step 106, the procedure proceeds to step 107 in which the computer determines whether the absolute value of the variation ΔNE is less than a specified value ΔNE0 and the absolute value of the variation ΔNL is less than a specified value ΔNL0, whereby the computer determines whether the combustion condition of the engine 11 is stable. When the answer is YES in step 107, the procedure proceeds to step 108 in which the computer determines whether the gas temperature “Tegr” is greater than an upper threshold.

When the answer is NO in step 108, the procedure goes back to step 104. When the answers are NO in steps 106 or step 107, this routine ends.

When the answer is YES in step 108, the procedure proceeds to step 109 shown in FIG. 5. In step 109, the EGR valve 31 is driven so that the EGR opening degree increases at a specified speed. The EGR opening degree may be increased linearly or stepwise.

Then, the procedure proceeds to step 110 in which the computer read the EGR opening degree “Aegr” and the gas temperature “Tegr”. In step 111, the computer determines whether the EGR opening degree “Aegr” is less than the upper threshold. The upper threshold is defined greater than the reference position of the EGR valve 31.

When the answer is YES in step 111, the procedure proceeds to step 112 in which the computer determines whether the absolute value of the variation ΔNE is less than the specified value ΔNE0 and the absolute value of the variation ΔNL is less than the specified value ΔNL0, whereby the computer determines whether the combustion condition of the engine 11 is stable. When the answer is YES in step 112, the procedure proceeds to step 113 in which the computer determines whether the gas temperature “Tegr” is greater than the upper threshold.

When the answer is NO in step 113, the procedure goes back to step 109. When the answer is NO in step 111 or step 112, the routine ends.

When the answer is YES in step 113, the procedure proceeds to step 114 in which the computer computes an EGR opening degree “Aegr[min(Tegr)]” at which the gas temperature “Tegr” becomes minimum. This EGR opening degree “Aegr[min(Tegr)]” is learned as the full-close position.
Learning value of full-close position “EGRVst”=Aegr[min(Tegr)]

This learning value “EGRVst” is stored in a nonvolatile memory, such as a backup RAM of the ECU 36. In this case, the learning value of the full-close position “EGRVst” is added to the target EGR opening degree corresponding to the target EGR quantity is defined as the final target EGR opening degree.

According to the above first embodiment, since the EGR opening degree at which the variation in gas temperature becomes minimum is learned as the full-close position, the full-close position of the EGR valve 31 can be accurately learned.

Furthermore, since the gas temperature sensor 33 detects the EGR gas temperature before the EGR gas flows into the intake air, the EGR gas temperature is accurately detected by the sensor 33 so that the learning accuracy of the full-close position of the EGR valve 31 can be improved.

When learning the full-close position, the opening degree of the EGR valve 31 at which the detected gas temperature becomes minimum is computed. The opening degree at which a variation in gas temperature becomes minimum is obtained and learned as the full-close position. Thus, the full-close position of the EGR valve 31 can be easily obtained.

In the above first embodiment, when learning the full-close position, the opening degree of the EGR valve 31 is made smaller than the reference position and then the opening degree is increased more than the reference position. However, after the opening degree of the EGR valve 31 is increased than the reference position and then the opening degree may be decreased.

### Second Embodiment

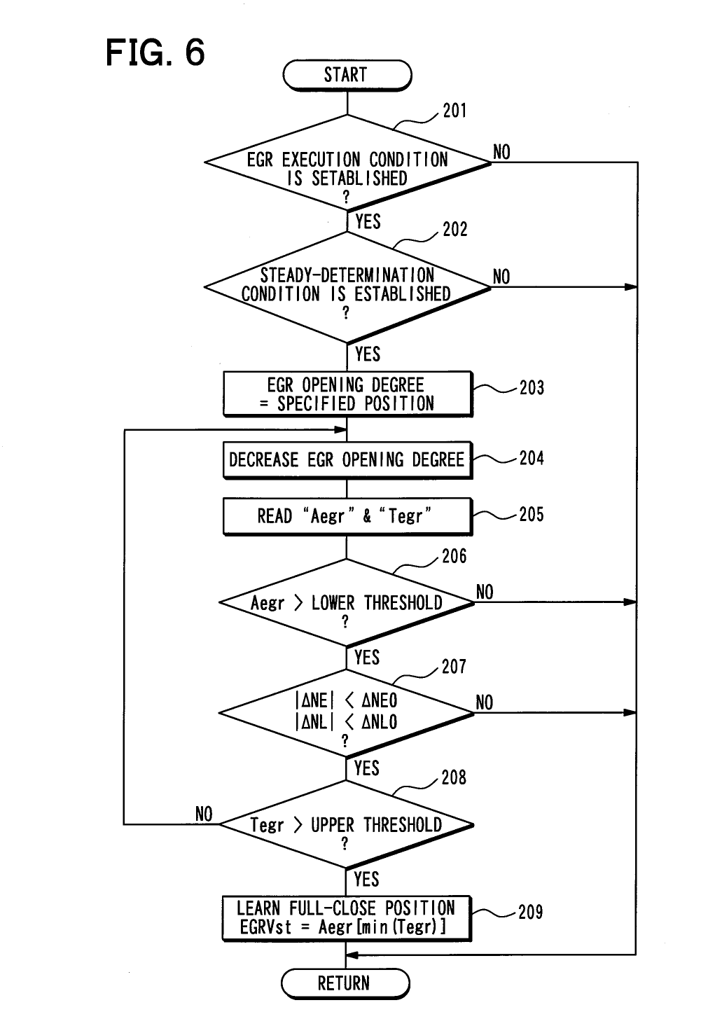

Referring to FIG. 6, a second embodiment will be described hereinafter. In the second embodiment, the same parts and components as those in the first embodiment are indicated with the same reference numerals and the same descriptions will not be reiterated.

According to the second embodiment, the ECU 36 executes a full-close position learning routine shown in FIG. 6. When a specified learning-executing condition is established, the EGR valve 31 is compulsorily rotated from a position of which opening degree is larger than that of a reference position (for example, a designed full-close position or a previously learned full-close position) to a position of which opening degree is smaller than that of the reference position through the full-close position. At a time when a variation in temperature detected by the gas temperature sensor 33 becomes minimum, its opening degree of the EGR valve 31 is learned as the full-close position.

In step 201, the computer determines whether an EGR execution condition is established. That is, the computer determines whether the combustion stability of the engine 11 can be ensured even if the opening degree of the EGR valve 31 is varied. When the answer is YES in step 201, the procedure proceeds to step 202 in which the computer determines whether a steady-determination condition is established.

When the answer is NO in step 201, or when the answer is NO in step 202, it is determined that the learning executing condition is not established to end the routine.

Meanwhile the answers are YES in steps 201 and 202, the procedure proceeds to step 203.

In step 203, the EGR valve 31 is driven so that the opening degree of thee EGR valve 31 is brought into a specified position. The opening degree of thee EGR valve 31 is referred to as an EGR opening degree as well as the first embodiment. The opening degree of the above specified position is defined greater than that of the reference position of the EGR valve 31.

Then, the procedure proceeds to step 204 in which the EGR valve 31 is driven so that the EGR opening degree is decreased at a specified speed. The EGR opening degree may be decreased linearly or stepwise.

Then, the procedure proceeds to step 205 in which the computer reads an EGR opening degree “Aegr” detected by the sensor 32 and a gas temperature “Tegr” detected by the temperature sensor 33. In step 206, the computer determines whether the EGR opening degree “Aegr” is greater than a lower threshold. The lower threshold is defined smaller than the reference position of the EGR valve 31.

When the answer is YES in step 206, the procedure proceeds to step 207 in which the computer determines whether the absolute value of the variation ΔNE is less than a specified value ΔNE0 and the absolute value of the variation ΔNL is less than a specified value ΔNL0, whereby the computer determines whether the combustion condition of the engine 11 is stable. When the answer is YES in step 207, the procedure proceeds to step 208 in which the computer determines whether the gas temperature “Tegr” is greater than the upper threshold.

When the answer is NO in step 208, the procedure goes back to step 204. When the answer is No in step 206 or step 207, this routine ends.

When the answer is YES in step 208, the procedure proceeds to step 209 in which the computer computes an EGR opening degree “Aegr[min(Tegr)]” at which the gas temperature “Tegr” becomes minimum. This EGR opening degree “Aegr[min(Tegr)]” is learned as the full-close position.
Learning value of full-close position “EGRVst”=Aegr[min(Tegr)]

According to the above second embodiment, when a specified learning-executing condition is established, the EGR valve 31 is compulsorily rotated from a position of which opening degree is larger than that of a reference position to a position of which opening degree is smaller than that of the reference position through the full-close position. Since the EGR opening degree at which the variation in gas temperature becomes minimum is learned as the full-close position, the full-close position of the EGR valve 31 can be accurately learned.

Meanwhile, the EGR valve 31 may be compulsorily rotated from a position of which opening degree is smaller than that of the reference position to a position of which opening degree is larger than that of the reference position through the full-close position.

In the above embodiments, when learning the full-close position, the opening degree of the EGR valve 31 at which the detected gas temperature becomes minimum is computed. The opening degree at which a variation in gas temperature becomes minimum is obtained and learned as the full-close position. However, a middle opening degree of the EGR valve 31 at which the detected gas temperature becomes smaller than a specified threshold, whereby the EGR opening degree at which the gas temperature becomes minimum may be obtained. Alternatively, a variation speed in the gas temperature detected by the gas temperature sensor 33 is computed, and the EGR opening degree at which the variation speed in the gas temperature becomes minimum may be obtained.

Moreover, the learning executing condition may be established while the engine is at idling. Only when the learning executing condition is firstly established after the engine is started, the full-close position learning may be executed. Alternatively, when the learning executing condition is established after a specified time period is elapsed since the last full-close position learning, the full-close position learning may be executed.

The gas temperature sensor 33 may be arranged upstream of the EGR valve 31 in the EGR pipe 29. Alternatively, the gas temperature sensor 33 may be arranged in the intake pipe downstream of a confluent portion between the intake pipe 12 and the EGR pipe 29. Alternatively, the gas temperature sensor 33 may be arranged in the surge tank 23 or the intake manifold 24.

In the above embodiments, the EGR controller is applied to a low-pressure-loop (LPL) type EGR apparatus 28. The EGR controller of the present disclosure can be applied to a high-pressure-loop (HPL) type EGR apparatus in which the exhaust gas is recirculated from upstream of the exhaust turbine in the exhaust pipe to downstream of the compressor in the intake pipe.

The present disclosure can be applied to an engine provided with a mechanical supercharger or an electrical supercharger.

Also, the present disclosure can be applied to an engine having no supercharger.

What is claimed is:

1. An EGR controller for an internal combustion engine, comprising:
an EGR valve controlling an exhaust gas quantity recirculating from an exhaust passage into an intake passage through an EGR passage;
a gas temperature detection portion detecting a gas temperature of the exhaust gas recirculating from the exhaust passage into the intake passage; and
a full-close position learning portion learning a full-close position of the EGR valve, wherein:
when a specified learning-executing condition is established, the opening degree of the EGR valve is compulsorily varied; and
an opening degree of the EGR valve at which a variation in the temperature detected by the gas temperature detection portion becomes minimum is learned as the full-close position of the EGR valve.

2. An EGR controller for an internal combustion engine, according to claim 1, wherein:
the gas temperature detection portion is arranged in the EGR passage.

3. An EGR controller for an internal combustion engine, according to claim 1, wherein:
when the full-close position learning portion learns the full-close position of the EGR valve, the opening degree of the EGR valve is decreased from a specified reference position and then increased, or the opening degree of the EGR valve is increased from the specified reference position and then decreased.

4. An EGR controller for an internal combustion engine, according to claim 1, wherein:
when the full-close position learning portion learns the full-close position of the EGR valve, the EGR valve is rotated from a position of which opening degree is smaller than that of the reference position to a position of which opening degree is larger than that of the reference position, or the EGR valve is rotated from a position of which opening degree is larger than that of the reference position to a position of which opening degree is smaller than that of the reference position.

5. An EGR controller for an internal combustion engine, according to claim 1, wherein:
when the full-close position learning portion learns the full-close position of the EGR valve, an opening degree of the EGR valve at which the gas temperature becomes minimum or a middle opening degree of the EGR valve at which the gas temperature becomes lower than a specified threshold is computed as an opening degree of the EGR valve at which a variation in the temperature detected by the gas temperature detection portion becomes minimum.

6. An EGR controller for an internal combustion engine, according to claim 1, wherein:
the full-close position learning portion executes a learning of the full-close position of the EGR valve when the learning executing condition is established in which a combustion stability of the internal combustion engine is ensured even if an opening degree of the EGR valve is varied.

7. An EGR controller for an internal combustion engine, according to claim 2, wherein:
the gas temperature detection portion is arranged downstream of the EGR valve in the EGR passage.
